(19) United States
(12) Patent Application Publication
(10) Pub. No.: US 2024/0416887 A1
(43) Pub. Date: Dec. 19, 2024

(54) ELECTRO-MECHANICAL BRAKE SYSTEM AND METHOD FOR SETTING GEAR RATIO THEREOF

(71) Applicant: HL MANDO CORPORATION, Pyeongtaek-si (KR)

(72) Inventor: Jaesang PARK, Yongin-si (KR)

(73) Assignee: HL MANDO CORPORATION, Pyeongtaek-si (KR)

(21) Appl. No.: 18/385,096

(22) Filed: Oct. 30, 2023

(30) Foreign Application Priority Data
Jun. 15, 2023 (KR) 10-2023-0076542

(51) Int. Cl. B60T 13/74; F16D 65/16; H02P 6/10

(52) U.S. Cl. CPC B60T 13/746; F16D 65/16; H02P 6/10

(57) ABSTRACT

A method for setting a gear ratio for an EMB system according to an exemplary embodiment of the present disclosure allows for filtering out gear ratios of a reducer that are disadvantageous for torque ripple or noise characteristics, by excluding the same/similar orders to an order of ripple that can be generated in the motor, when setting a gear ratio of the reducer, performs cause analysis more easily when the EMB system has a (noise, vibration, or harshness) NVH issue, since the motor and the reducer have their own unique order/frequency characteristics, and performs optimization of the reducer at an early design stage by selecting values that are available and not available as the gear ratio of the reducer.

### TECHNICAL FIELD

The present disclosure relates to an EMB system and a method for setting a gear ratio thereof, and more particularly, relates to a system and method for setting a gear ratio of a reducer in an electro-mechanical brake (EMB) system.

### BACKGROUND

In an electro-mechanical brake (EMB) system using a motor and a reducer, if an order of torque ripple that may be generated in the motor and an order of ripple that may be generated in the reducer have similar overlapping values, noises will overlap at the same order/same frequency while the EMB system is operating, thereby deteriorating the noise, vibration, and harshness (NVH) characteristics of the EMB system.

### SUMMARY

An objective to be accomplished by the present disclosure is to provide an EMB system for setting a gear ratio of a reducer in an electro-mechanical brake (EMB) system in consideration of a motor and the noise, vibration, and harshness (NVH) characteristics of the motor during operation, and a method for setting a gear ratio thereof.

Other unspecified objectives of the present disclosure will be additionally considered within the scope that can be easily inferred from the following detailed description and effects thereof.

An exemplary embodiment of the present disclosure provides an EMB system including: a motor; and a reducer for amplifying an output of the motor, wherein a gear ratio of the reducer is selected from a group of reducer gear ratio candidates, by using reducer gear ratio candidates remaining after excluding a motor ripple generation order obtained based on specification information of the motor.

The motor may include a permanent magnet synchronous motor (PMSM), wherein the motor ripple generation order includes the number of poles and the number of slots in the PMSM.

The motor ripple generation order may include a basic generation order including a plurality of basic orders obtained based on the number of poles and the number slots.

The basic generation order may include a plurality of basic orders which are obtained based on a plurality of mechanical orders representing an order of ripple generated due to mechanical characteristics of the motor and a plurality of electrical orders representing an order of ripple generated due to electrical characteristics of the motor.

The plurality of mechanical orders may include a first mechanical order representing the number of poles, a second mechanical order representing the number of slots, a third mechanical order representing the least common multiple of the number of poles and the number of slots, and a fourth mechanical order representing twice as many as the third mechanical order, and the plurality of electrical orders may include a first electrical representing a half multiple of the number of poles and a second electrical order representing the number of poles.

The basic generation order may include a plurality of basic orders including the plurality of mechanical orders and the plurality of electrical orders altogether.

The motor ripple generation order may further include an extended generation order which is obtained by extending the basic generation order to a preset extended range.

The extended generation order may include a plurality of extended orders which are obtained by extending each of the plurality of basic orders of the basic generation order by using the extended range.

The extended range may represent one of ±1, ±2, and ±1 and ±2.

If the motor is operating at a frequency of a preset reference value or above, or the motor is operating at a varying speed, the motor ripple generation order may further include the extended generation order which is obtained by extending the basic generation order to the extended range.

The gear ratio of the reducer may be selected from a group of reducer gear ratio candidates consisting of gear ratios selectable for the reducer, by using reducer gear ratio candidates remaining after excluding gear ratio candidates corresponding to all orders included in the motor ripple generation order.

Another exemplary embodiment of the present disclosure provides a method for setting a gear ratio of an electro-mechanical brake (EMB) system including a motor and a reducer for amplifying an output of the motor, the method including: obtaining a motor ripple generation order based on specification information of the motor; and selecting a gear ratio of the reducer from a group of reducer gear ratio candidates, by using reducer gear ratio candidates remaining after excluding the obtained motor ripple generation order.

The motor may include a permanent magnet synchronous motor (PMSM), wherein the obtaining of a motor ripple generation order may include obtaining the motor ripple generation order based on the specification information including the number of poles and the number of slots in the PMSM.

The motor ripple generation order may include a basic generation order including a plurality of basic orders obtained based on the number of poles and the number slots.

The basic generation order may include a plurality of basic orders which are obtained based on a plurality of mechanical orders representing an order of ripple generated due to mechanical characteristics of the motor and a plurality of electrical orders representing an order of ripple generated due to electrical characteristics of the motor.

The plurality of mechanical orders may include a first mechanical order representing the number of poles, a second mechanical order representing the number of slots, a third mechanical order representing the least common multiple of the number of poles and the number of slots, and a fourth mechanical order representing twice as many as the third mechanical order, and the plurality of electrical orders include a first electrical representing a half multiple of the number of poles and a second electrical order representing the number of poles.

The basic generation order may include a plurality of basic orders including the plurality of mechanical orders and the plurality of electrical orders altogether.

The motor ripple generation order may further include an extended generation order which is obtained by extending the basic generation order to a preset extended range.

The extended generation order may include a plurality of extended orders which are obtained by extending each of the plurality of basic orders of the basic generation order by using the extended range.

If the motor is operating at a frequency of a preset reference value or above, or the motor is operating at a varying speed, the motor ripple generation order may further include the extended generation order which is obtained by extending the basic generation order to the extended range.

An EMB system and a method for setting a gear ratio thereof according to an exemplary embodiment of the present disclosure allows for filtering out gear ratios of a reducer that are disadvantageous for torque ripple or noise characteristics, by excluding the same/similar orders to an order of ripple that can be generated in the motor, when setting a gear ratio of the reducer, performs cause analysis more easily when the EMB system has a noise, vibration, or harshness (NVH) issue, since the motor and the reducer have their own unique order/frequency characteristics, and performs optimization of the reducer at an early design stage by selecting values that are available and not available as the gear ratio of the reducer.

The effects of the present disclosure are not limited to the above-mentioned effects, and other effects not mentioned will be clearly understood by those skilled in the art from the description of the claims.

### BRIEF DESCRIPTION OF THE DRAWINGS

FIG. 1 is a block diagram for explaining an EMB system according to an exemplary embodiment of the present disclosure.

FIG. 2 is a view for explaining an example of ripple generation in a motor according to an exemplary embodiment of the present disclosure.

FIG. 3 is a view showing an ideal operation in the motor illustrated in FIG. 2.

FIG. 4 is a view showing an operation in the motor illustrated in FIG. 2, when a magnet surface and an MPS are horizontally misaligned.

FIG. 5 is a view showing an operation in the motor illustrated in FIG. 2 in the case of concentric misalignment on one axis.

FIG. 6 is a view showing an operation in the motor illustrated in FIG. 2 in the case of concentric misalignment on both the X and Y axes.

FIG. 7 is a view showing ripple components that can be generated in the motor illustrated in FIG. 2.

FIG. 8 is a flowchart for explaining a method for setting a gear ratio for an EMB system according to an exemplary embodiment of the present disclosure.

### DETAILED DESCRIPTION

Advantages and features of the present disclosure and methods for achieving them will be made clear from the embodiments described below in detail with reference to the accompanying drawings. The present disclosure may, however, be embodied in many different forms, and should not be construed as being limited to the embodiments set forth herein. Rather, these embodiments are provided so that this disclosure will be thorough and complete, and will fully convey the scope of the present disclosure to those skilled in the art. The present disclosure is merely defined by the scope of the claims. Like reference numerals refer to like elements throughout the specification.

Unless otherwise defined, all terms (including technical and scientific terms) used herein have the same meanings as those commonly understood by one of ordinary skill in the art. It will be further understood that terms such as those defined in commonly used dictionaries should be interpreted as having meanings consistent with their meanings in the context of the relevant art and the present disclosure, and are not to be interpreted in an idealized or overly formal sense unless expressly so defined herein.

The terms such as first, second, etc. are intended to distinguish one element from another, and the scope of the right should not be limited by these terms. For example, the first component may be referred to as a second component, and similarly, the second component may also be referred to as a first component.

Identification codes (e.g., a, b, and c) of each step are merely used for better comprehension and ease of description, not indicating a specific order of the steps, and the steps may be performed in a different order from a described order, unless clearly limited otherwise. Specifically, the steps may be performed in the same order as the described order, may substantially simultaneously be performed, or may be performed in the reverse order.

The terms “have,” “may have,” “include,” and “may include” as used herein indicate the presence of corresponding features (for example, elements such as numerical values, functions, operations, or parts), and do not preclude the presence of additional features.

The term “˜unit”, as used herein, refers to a software component or a hardware component, such as a field programmable gate array (FPGA) or application specific integrated circuit (ASIC), and a unit performs certain tasks. However, the meaning of the ‘˜unit’ is not limited to software or hardware. A unit may be configured to reside on an addressable storage medium and be configured to execute on one or more processors. For example, a unit may include components, such as software components, object-oriented software components, class components, and task components, processes, functions, attributes, procedures, subroutines, segments of program code, drivers, firmware, microcode, circuitry, data, databases, data structures, tables, arrays, and variables. The functions provided in the components and units may be combined into fewer components and units, or further separated into additional components and units.

Hereinafter, an EMB system and a method for setting a gear ratio thereof according to an exemplary embodiment of the present disclosure will be described in detail with reference to the accompanying drawings.

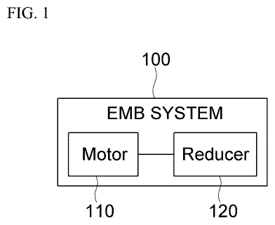

First, an EMB system according to an exemplary embodiment of the present disclosure will be described with reference to FIGS. 1 to 7.

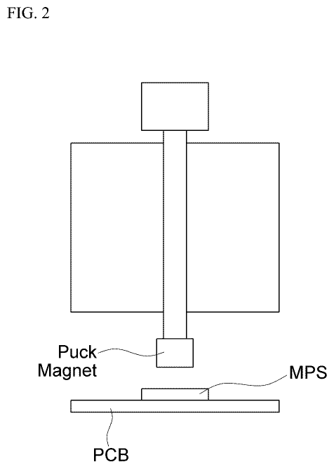

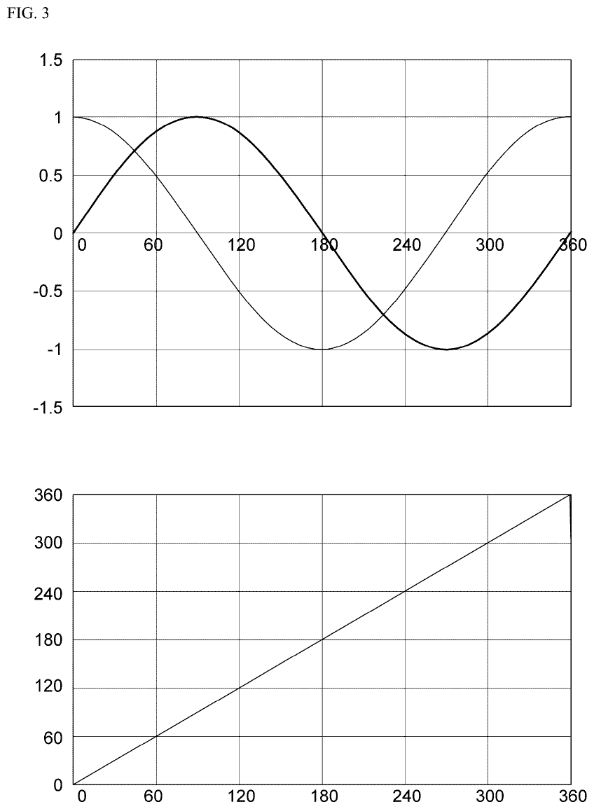

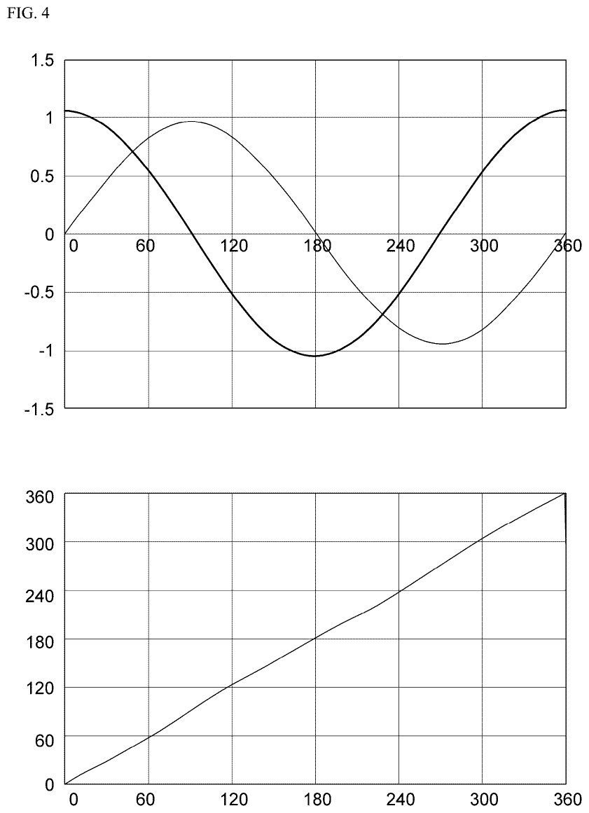

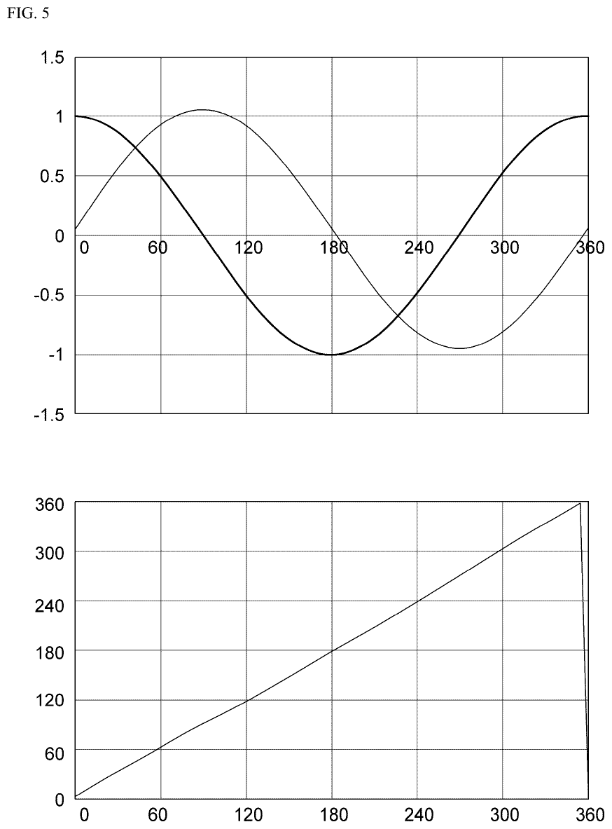

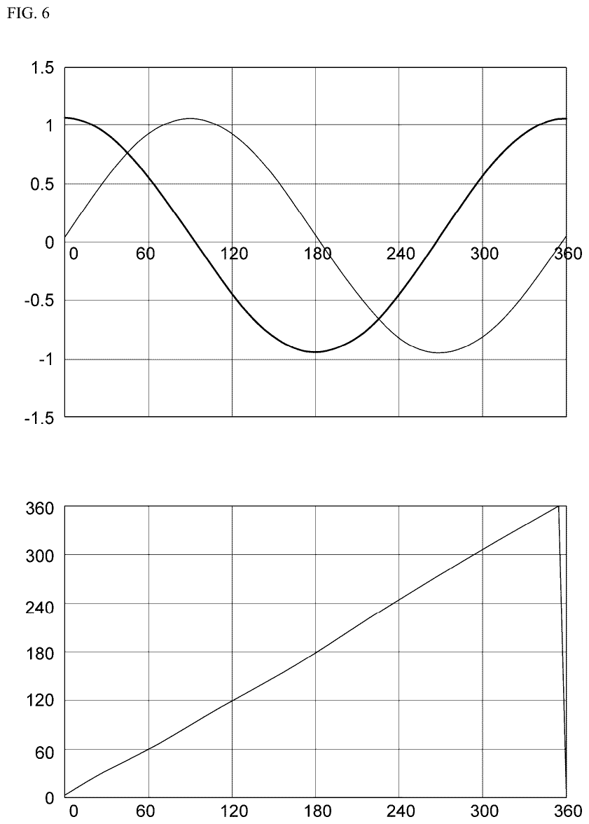

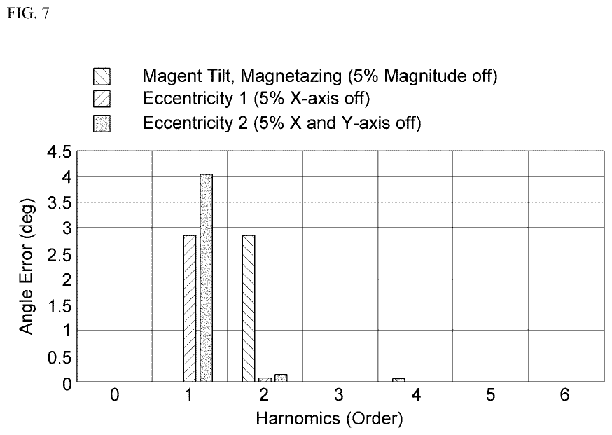

FIG. 1 is a block diagram for explaining an EMB system according to an exemplary embodiment of the present disclosure. FIG. 2 is a view for explaining an example of ripple generation in a motor according to an exemplary embodiment of the present disclosure. FIG. 3 is a view showing an ideal operation in the motor illustrated in FIG. 2. FIG. 4 is a view showing an operation in the motor illustrated in FIG. 2, when a magnet surface and an MPS are horizontally misaligned. FIG. 5 is a view showing an operation in the motor illustrated in FIG. 2 in the case of concentric misalignment on one axis. FIG. 6 is a view showing an operation in the motor illustrated in FIG. 2 in the case of concentric misalignment on both the X and Y axes. FIG. 7 is a view showing ripple components that can be generated in the motor illustrated in FIG. 2.

Referring to FIG. 1, an electro-mechanical brake (EMB) system according to an exemplary embodiment of the present disclosure includes a motor 110 and a reducer 120 for amplifying an output of the motor 110, and may set a gear ratio of the reducer 120 in consideration of the motor 110 and the noise, vibration, and harshness (NVH) characteristics of the motor 110 during operation.

Accordingly, the present disclosure may allow for filtering out gear ratios of the reducer 120 that are disadvantageous for torque ripple or noise characteristics, by excluding the same/similar orders to an order of ripple that can be generated in the motor, when setting a gear ratio of the reducer 120, may perform cause analysis more easily when the EMB system has an NVH issue, since the motor 110 and the reducer 120 have their own unique order/frequency characteristics, and may perform optimization of the reducer 120 at an early design stage by selecting values that are available and not available as the gear ratio of the reducer 120.

That is, the motor 110 may include a permanent magnet synchronous motor (PMSM).

Also, the reducer 120 is used as a medium for amplifying/transmitting an output of the motor 110, and may come in various types such as a belt pulley, a worm-worm wheel, a planetary gear, a ball nut, and so on.

In this case, the gear ratio of the reducer 120 may be selected from a group of reducer gear ratio candidates, by using reducer gear ratio candidates remaining after excluding a motor ripple generation order obtained based on specification information of the motor 110. That is, the gear ratio of the reducer 120 may be selected from a group of reducer gear ratio candidates consisting of gear ratios selectable for the reducer 120, by using reducer gear ratio candidates remaining after excluding gear ratio candidates corresponding to all orders included in the motor ripple generation order.

More specifically, the motor ripple generation order may be obtained based on specification information including the number of poles and the number of slots in the permanent magnet synchronous motor (PMSM). For example, a ripple order represents a value into which a characteristic of ripple generated when the motor 110 rotates mechanically with respect to a shaft is converted. If one ripple is generated per turn, the ripple order may be defined as first, and, if two ripples are generated per turn, the ripple order may be defined as second. In this case, a mechanical order refers to an order generated when the shaft of the motor 110 mechanically rotates 360 degrees, i.e., one turn. An electrical order refers to an order generated when, in the case of a three-phase motor, a sine wave completes one cycle with respect to counter-electromotive voltage or current.

That is, the motor ripple generation order may include a basic generation order including a plurality of basic orders obtained based on the number of poles and the number slots. Here, the basic generation order may include a plurality of basic orders which are obtained based on a plurality of mechanical orders representing an order of ripple generated due to mechanical characteristics of the motor 110 and a plurality of electrical orders representing an order of ripple generated due to electrical characteristics of the motor 110. The plurality of mechanical orders may include a first mechanical order, a second mechanical order, a third mechanical order, and a fourth mechanical order. The first mechanical order is a ripple order generated due to a slot manufacturing problem or manufacturing dispersion, and may represent the number of poles. The second mechanical order is a ripple order generated due to a rotor manufacturing problem or manufacturing dispersion, and may represent the number of slots. The third mechanical order is an order generated at which the highest torque ripple is generated in terms of electromagnetic system design, and may represent the least common multiple of the number of poles and the number of slots. The fourth mechanical order is a ripple order generated due to counter-electromotive voltage characteristics of the motor 110, and may represent twice as many as the third mechanical Also, the plurality of electrical orders may include a first electrical order and a order. second electrical order. The first electrical order is a ripple order generated due to an offset error of a current sensor or a device dispersion, and may represent a half multiple of the number of poles. The second electrical order is a ripple order generated due to a gain error of a current sensor or a device dispersion, and may represent the number of poles. In other words, the basic generation order may include a plurality of basic orders including the plurality of mechanical orders and the plurality of electrical orders altogether.

For example, if the number of poles is “N” and the number of slots is “M”, the motor ripple generation order may include such a basic generation order as in [Table 1].

TABLE 1

| | | N = 6 & | N = 8 & | N = 10 & |
|---|---|---|---|---|
| | | M = 9 | M = 12 | M = 12 |
| First | 1*N/2 | 3 | 4 | 5 |
| electrical order | | | | |
| Second | 2*N/2 | 6 | 8 | 10 |
| electrical order | | | | |
| First | N | 6 | 8 | 10 |
| mechanical order | | | | |
| Second | M | 9 | 12 | 12 |
| mechanical order | | | | |
| Third | Least common | 18 | 24 | 60 |
| mechanical order | multiple of | | | |
| | N and M | | | |
| Forth | 2*(third | 36 | 48 | 120 |
| mechanical order | mechanical | | | |
| | order) | | | |

| | | | |
|---|---|---|---|
| Basic generation order | 3, 6, 9, | 4, 8, 12, | 5, 10, 12, |
| | 18, 36 | 24, 48 | 60, 120 |

Furthermore, the motor ripple generation order may further include an extended generation order which is obtained by extending the basic generation order to a preset extended range. Here, the extended generation order may include a plurality of extended orders which are obtained by extending each of the plurality of basic orders of the basic generation order by using the extended range. In this case, the extended range may represent one of ±1, ±2, and ±1 and ±2. That is, the extended range may cover each basic order and −2 to ±2 of that order.

In this case, if the motor 110 is operating at a frequency of a preset reference value (1,000 rpm or the like) or above, or the motor 110 is operating at a varying speed, rather than at a constant speed, the motor ripple generation order may further include the extended generation order which is obtained by extending the basic generation order to the extended range. For example, if the motor 110 operates mainly at a speed of 1,000 rpm, the twelfth order corresponds to 2,000 Hz. This means that the tenth order which is the twelfth order minus 2 corresponds to 167 Hz, the fourteenth order which is the twelfth order plus 2 corresponds to 233 Hz, the twenty-fourth order corresponds to 400 Hz, the twenty-second order which is the twenty-fourth order minus 2 corresponds to 367 Hz, and the twenty-sixth order which is the twenty-fourth order plus 2 corresponds to 433 Hz. As such, the intervals between the orders are narrow compared to frequencies to be analyzed, making NVH analysis difficult. Also, a large quantity of input data is required for precise analysis. However, in a speed-varying system, it is not easy to obtain adequate data required for analysis within the same speed. Moreover, frequencies a human's ears hear merge into a single frequency toward higher frequencies. Thus, it is necessary to eliminate only precise multiples of orders in a system operating at a low constant speed and to exclude orders to an extended range in a system operating at varying speeds. That is, if the motor 110 operates mainly at a speed of 500 rpm, the twelfth order corresponds to 1,000 Hz. This means that the tenth order which is the twelfth order minus 2 corresponds to 83 Hz, the fourteenth order which is the twelfth order plus 2 corresponds to 117 Hz, the twenty-fourth order corresponds to 200 Hz, the twenty-second order which is the twenty-fourth order minus 2 corresponds to 183 Hz, and the twenty-sixth order which is the twenty-fourth order plus 2 corresponds to 217 Hz. These frequencies correspond to a low-frequency range in which humans or NVH equipment can detect frequencies relatively easily.

For example, if the number of poles is “N”, the number of slots is “M”, and the extended range is “±1 and ±2”, the motor ripple generation order may include such a basic generation order as in [Table 2].

TABLE 2

| | | | |
|---|---|---|---|
| Basic | Extended | Extended | Motor ripple |
| generation | generation | generation | generation |
| order | order(+1) | order(+2) | order |

N = 6 & M = 9

| | | | |
|---|---|---|---|
| 3 | 2, 4 | 1, 5 | 1, 2, 3, 4, 5 |
| 6 | 5, 7 | 4, 8 | 4, 5, 6, 7, 8 |
| 9 | 8, 10 | 7, 11 | 7, 8, 9, 10, 11 |
| 18 | 17, 19 | 16, 20 | 16, 17, 18, 19, 20 |
| 36 | 35, 37 | 34, 38 | 34, 35, 36, 37, 38 |

N = 8 & M = 12

| | | | |
|---|---|---|---|
| 4 | 3, 5 | 2, 6 | 2, 3, 4, 5, 6 |
| 8 | 7, 9 | 6, 10 | 6, 7, 8, 9, 10 |
| 12 | 11, 13 | 10, 14 | 10, 11, 12, 13, 14 |
| 24 | 23, 25 | 22, 26 | 22, 23, 24, 25, 26 |
| 48 | 47, 49 | 46, 50 | 46, 47, 48, 49, 50 |

N = 10 & M = 12

| | | | |
|---|---|---|---|
| 5 | 4, 6 | 3, 7 | 3, 4, 5, 6, 7 |
| 10 | 9, 11 | 8, 12 | 8, 9, 10, 11, 12 |
| 12 | 11, 13 | 10, 14 | 10, 11, 12, 13, 14 |
| 60 | 59, 61 | 58, 62 | 58, 59, 60, 61, 62 |
| 120 | 119, 121 | 118, 122 | 118, 119, 120, 121, 122 |

The reason why the extended generation order (±1, ±2, or ±1 and ±2) which is obtained by extending the basic generation order to a preset extended range is considered will be described with reference to FIGS. 2 to 7.

In the case of MPS (motor position sensor), as illustrated in FIG. 2, a puck magnet for sensing is attached to an end of a rotor of the motor, and a sensor for measuring the magnetic flux of the magnet, i.e., MPS, is mounted onto a PCB.

Under an ideal condition in which all requirements are correctly met, such as when the centers of the magnet and the MPS are correctly aligned and the magnet and the MPS are perfectly horizontal, harmonics are not produced. However, errors are inevitable in manufacturing processes. These errors are generated because, in the MPS, the sine and cosine of each flux are out of phase by 90 degrees, depending on the structural conditions of the MPS, and the rotor's angle is calculated by using arctangent.

Under an ideal condition, angles are calculated without problems. On the other hand, as illustrated in FIG. 3, if a side of the magnet and a side of the MPS are not horizontal to each other (the magnet is attached at a slight tilt, or the PCB or the MPS is horizontally misaligned), or if horizontal misalignment is caused when the magnet is magnetized, a primary ripple component is incorporated into angle information as illustrated in FIG. 4. Also, if the magnet and the MPS are concentrically misaligned because of deviation on either the X axis or the Y axis, a primary ripple component is generated as illustrated in FIG. 5. Moreover, if they are concentrically misaligned on both the X axis and the Y axis, a primary ripple component is generated as illustrated in FIG. 6. To sum up, in the case of a product using MPS, a primary ripple component and a secondary ripple component may be potentially included as illustrated in FIG. 7. Since the generated ripple components are incorporated into control input and produce current and voltage, ±1 orders and ±2 orders are additionally generated. Accordingly, the present disclosure is able to obtain a motor ripple generation order in consideration of an extended generation order which is obtained by extending a basic generation order to a preset extended range.

Afterwards, the gear ratio of the reducer 120 may be selected from a group of reducer gear ratio candidates consisting of gear ratios selectable for the reducer 120, by using reducer gear ratio candidates remaining after excluding gear ratio candidates corresponding to all orders included in the motor ripple generation order. For example, in the case of a 8-pole, 12-slot, permanent magnet synchronous motor (PMSM), the gear ratio of the reducer 120 may be selected from a group of reducer gear ratio candidates, by using reducer gear ratio candidates remaining after excluding gear ratio candidates corresponding to all orders included in the ripple generation order of the motor 110, including 2nd, 3rd, 4th, 5th, and 6th orders/6th, 7th, 8th, 9th, and 10th orders/10th, 11th, 12th, 13th, and 14th orders/22th, 23th, 24th, 25th, and 26th orders/46th, 47th, 48th, 49th, and 50th orders”.

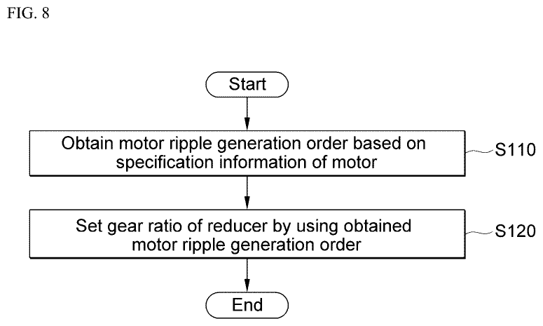

Next, a method for setting a gear ratio for an EMB system according to an exemplary embodiment of the present disclosure will be described with reference to FIG. 8.

FIG. 8 is a flowchart for explaining a method for setting a gear ratio for an EMB system according to an exemplary embodiment of the present disclosure.

Referring to FIG. 8, the EMB system 100 may obtain a motor ripple generation order based on specification information of the motor 110 (S110).

That is, the EMB system 100 may obtain a motor ripple generation order based on specification information including the number of poles and the number of slots in the permanent magnet synchronous motor (PMSM).

That is, the motor ripple generation order may include a basic generation order including a plurality of basic orders obtained based on the number of poles and the number slots. Here, the basic generation order may include a plurality of basic orders which are obtained based on a plurality of mechanical orders representing an order of ripple generated due to mechanical characteristics of the motor and a plurality of electrical orders representing an order of ripple generated due to electrical characteristics of the motor 110. The plurality of mechanical orders may include a first mechanical order, a second mechanical order, a third mechanical order, and a fourth mechanical order. The first mechanical order may represent the number of poles. The second mechanical order may represent the number of slots. The third mechanical order may represent the least common multiple of the number of poles and the number of slots. The fourth mechanical order may represent twice as many as the third mechanical order. Also, the plurality of electrical orders may include a first electrical order and a second electrical order. The first electrical may represent a half multiple of the number of poles. The second electrical order may represent the number of poles. In other words, the basic generation order may include a plurality of basic orders including the plurality of mechanical orders and the plurality of electrical orders altogether.

Furthermore, the motor ripple generation order may further include an extended generation order which is obtained by extending the basic generation order to a preset extended range. Here, the extended generation order may include a plurality of extended orders which are obtained by extending each of the plurality of basic orders of the basic generation order by using the extended range. In this case, the extended range may represent one of ±1, ±2, and ±1 and ±2.

In this case, if the motor 110 is operating at a frequency of a preset reference value (1,000 rpm or the like) or above, or the motor 110 is operating at a varying speed, rather than at a constant speed, the motor ripple generation order may further include the extended generation order which is obtained by extending the basic generation order to the extended range.

Afterwards, the EMB system 100 may set a gear ratio of the reducer 120 by using the obtained motor ripple generation order (S120).

That is, the EMB system 100 may select the gear ratio of the reducer 120 from a group of reducer gear ration candidates, by using reducer gear ratio candidates remaining after excluding the obtained motor ripple generation order. In other words, the EMB system 100 may select the gear ratio of the reducer 120 from a group of reducer gear ratio candidates consisting of gear ratios selectable for the reducer 120, by using reducer gear ratio candidates remaining after excluding gear ratio candidates corresponding to all orders included in the motor ripple generation order.

Although it is described above that all elements constituting the embodiment of the present disclosure are combined or operated in combination, the present disclosure is not necessarily limited to what has been described herein. That is, two or more of the elements constituting the embodiment of the present disclosure can be selectively combined with one another or operated in combination with one another as long as such combination is within the object of the present invention. Moreover, although it is possible that every element is realized as its own individual hardware, it is also possible that some or all of the elements are selectively combined with one another to be realized as a computer program having a program module that performs the combined some or all functions in one or more hardware. Moreover, the embodiment of the present invention can be realized by having said computer program stored in computer-readable media, such as USB memory, CD disk, flash memory, etc., and read and executed by a computer. The computer-readable media can also include magnetic recording media, optical recording media, etc.

The above description is merely illustrative of the technical idea of the present disclosure, and those of ordinary skill in the art to which the present disclosure pertains may make various modifications, changes, and substitutions without departing from the essential characteristics of the present disclosure. Therefore, the embodiments disclosed in the present disclosure and the accompanying drawings are not intended to limit the technical spirit of the present disclosure, but to explain the scope of the technical spirit of the present disclosure. The scope of protection of the present disclosure should be interpreted by the claims below, and all technical spirits within the scope equivalent thereto should be interpreted as being included in the scope of the present disclosure.

What is claimed is:

1. An EMB system comprising:
a motor; and
a reducer for amplifying an output of the motor,
wherein a gear ratio of the reducer is selected from a group of reducer gear ratio candidates, by using reducer gear ratio candidates remaining after excluding a motor ripple generation order obtained based on specification information of the motor.

2. The EMB system of claim 1, wherein the motor includes a permanent magnet synchronous motor (PMSM),
wherein the motor ripple generation order includes the number of poles and the number of slots in the PMSM.

3. The EMB system of claim 2, wherein the motor ripple generation order includes a basic generation order including a plurality of basic orders obtained based on the number of poles and the number slots.

4. The EMB system of claim 3, wherein the basic generation order includes a plurality of basic orders which are obtained based on a plurality of mechanical orders representing an order of ripple generated due to mechanical characteristics of the motor and a plurality of electrical orders representing an order of ripple generated due to electrical characteristics of the motor.

5. The EMB system of claim 4, wherein the plurality of mechanical orders include a first mechanical order representing the number of poles, a second mechanical order representing the number of slots, a third mechanical order representing the least common multiple of the number of poles and the number of slots, and a fourth mechanical order representing twice as many as the third mechanical order, and
the plurality of electrical orders include a first electrical representing a half multiple of the number of poles and a second electrical order representing the number of poles.

6. The EMB system of claim 5, wherein the basic generation order includes a plurality of basic orders including the plurality of mechanical orders and the plurality of electrical orders altogether.

7. The EMB system of claim 3, wherein the motor ripple generation order further includes an extended generation order which is obtained by extending the basic generation order to a preset extended range.

8. The EMB system of claim 7, wherein the extended generation order includes a plurality of extended orders which are obtained by extending each of the plurality of basic orders of the basic generation order by using the extended range.

9. The EMB system of claim 8, wherein the extended range represents one of ±1, ±2, and ±1 and ±2.

10. The EMB system of claim 7, wherein, if the motor is operating at a frequency of a preset reference value or above, or the motor is operating at a varying speed, the motor ripple generation order further includes the extended generation order which is obtained by extending the basic generation order to the extended range.

11. The EMB system of claim 1 wherein, the gear ratio of the reducer is selected from a group of reducer gear ratio candidates consisting of gear ratios selectable for the reducer, by using reducer gear ratio candidates remaining after excluding gear ratio candidates corresponding to all orders included in the motor ripple generation order.

12. A method for setting a gear ratio of an electro-mechanical brake (EMB) system including a motor and a reducer for amplifying an output of the motor, the method comprising:
obtaining a motor ripple generation order based on specification information of the motor; and
selecting a gear ratio of the reducer from a group of reducer gear ratio candidates, by using reducer gear ratio candidates remaining after excluding the obtained motor ripple generation order.

13. The method of claim 12, wherein the motor includes a permanent magnet synchronous motor (PMSM),
wherein the obtaining of a motor ripple generation order includes obtaining the motor ripple generation order based on the specification information including the number of poles and the number of slots in the PMSM.

14. The method of claim 13, wherein the motor ripple generation order includes a basic generation order including a plurality of basic orders obtained based on the number of poles and the number slots.

15. The method of claim 14, wherein the basic generation order includes a plurality of basic orders which are obtained based on a plurality of mechanical orders representing an order of ripple generated due to mechanical characteristics of the motor and a plurality of electrical orders representing an order of ripple generated due to electrical characteristics of the motor.

16. The method of claim 15, wherein the plurality of mechanical orders include a first mechanical order representing the number of poles, a second mechanical order representing the number of slots, a third mechanical order representing the least common multiple of the number of poles and the number of slots, and a fourth mechanical order representing twice as many as the third mechanical order, and
the plurality of electrical orders include a first electrical representing a half multiple of the number of poles and a second electrical order representing the number of poles.

17. The method of claim 16, wherein the basic generation order includes a plurality of basic orders including the plurality of mechanical orders and the plurality of electrical orders altogether.

18. The method of claim 14, wherein the motor ripple generation order further includes an extended generation order which is obtained by extending the basic generation order to a preset extended range.

19. The method of claim 18, wherein the extended generation order includes a plurality of extended orders which are obtained by extending each of the plurality of basic orders of the basic generation order by using the extended range.

20. The method of claim 18, wherein, if the motor is operating at a frequency of a preset reference value or above, or the motor is operating at a varying speed, the motor ripple generation order further includes the extended generation order which is obtained by extending the basic generation order to the extended range.
